(19) United States
(12) Patent Application Publication
(10) Pub. No.: US 2015/0267705 A1
(43) Pub. Date: Sep. 24, 2015

(54) PUMP ARRANGEMENT

(71) Applicant: Mahle International GmbH, Stuttgart (DE)

(72) Inventors: Peter Dodel, Sonneberg (DE); Marco Kirchner, Poppenwind (DE); Christian Richter, Schleusingen (DE)

(21) Appl. No.: 14/660,482

(22) Filed: Mar. 17, 2015

(30) Foreign Application Priority Data
Mar. 18, 2014 (DE) 102014204946.6

(51) Int. Cl. F04D 13/12; F04D 7/00; F04D 29/18; F04C 15/00; F04D 29/044; F04D 29/64; F04C 2/344; F04C 13/00; F04D 3/00; F04D 29/20

(52) U.S. Cl. CPC F04D 13/12; F04D 3/005; F04D 7/00; F04D 29/181; F04D 29/20; F04D 29/044; F04D 29/648; F04C 2/3448; F04C 13/001; F04C 15/0061; F05C 2225/08

(57) ABSTRACT

A pump arrangement may include a pendulum-slide cell oil pump and a vacuum pump. The pendulum-slide cell oil pump and the vacuum pump may be driven by a common shaft and may be mounted in a common housing. The vacuum pump may be configured as a rotary vane pump and include a rotor composed of a plastic.

### CROSS-REFERENCE TO RELATED APPLICATIONS

This application claims priority to German Patent Application No. 10 2014 204 946.6, filed Mar. 18, 2014, the contents of which are hereby incorporated by reference in their entirety.

### TECHNICAL FIELD

The present invention relates to a pump arrangement comprising a pendulum-slide cell oil pump and a vacuum pump.

### BACKGROUND

In modern motor vehicles, the installation space available in the in the engine compartment is often the limiting factor so that research is increasingly focused on developing compact components such as, for example, pumps.

### SUMMARY

The present invention is therefore concerned with the problem of providing a pump arrangement that is designed to be particularly compact.

This problem is solved according to the invention by the subject matter of the independent claims. Advantageous embodiments are subject matter to the dependent claims.

The present invention is based on the general idea of no longer designing two pumps separately and accommodating them at separate installation locations in the engine compartment, as required in modern motor vehicles, but rather combining them in a pump arrangement according to the invention, that is, mounting them in a common housing and driving them by a common shaft. In this case, the two combined pumps are designed as a pendulum-slide cell oil pump and a low-pressure pump, for example for a brake system of the motor vehicle. Also, by driving both pumps by a common shaft, only one drive unit is required, as a result of which not only the required installation space can be significantly reduced, but it is also possible to eliminate an additional second drive unit, for example an electric motor, resulting in considerable cost advantages.

Advantageously, the low-pressure pump is designed as a vacuum pump or a rotary vane pump and has a rotor made of plastics. Such a rotor from plastics can be produced in high quality and in a comparatively cost-effective manner, wherein, moreover, plastic materials have a significantly lower weight compared with a construction from metal so that installing the pump arrangement according to the invention in a motor vehicle helps in particular to reduce fuel consumption and therefore also pollutant emissions.

Advantageously, the pendulum-slide cell oil pump and the vacuum pump are arranged coaxially. The construction is similar to an exhaust gas turbocharger, wherein the pendulum-slide cell oil pump is arranged on the one side and the vacuum pump is arranged on the opposing other side. Between both of them, a mounting housing or generally a housing of the pump arrangement is arranged, in which housing the shaft and thus also the inner rotor of the pendulum-slide cell oil pump and the rotor of the rotary vane pump, that is, of the vacuum pump, is mounted. Theoretically, the shaft could additionally be mounted in a vacuum pump cover or the pendulum-slide cell oil pump cover located opposite the mounting housing; however, this is not absolutely necessary so that mounting the shaft can generally be carried out exclusively in the mounting housing.

Advantageously, the rotor is injection molded on the shaft and has a transverse groove in which a vane of the vacuum pump, which is designed as a rotary vane pump, is supported in a sliding manner. By injection molding the rotor of the vacuum pump directly on the shaft, the mounting process of the pump arrangement can be significantly simplified. Theoretically, the shaft can have a projecting or non-round outer contour on the circumferential outer surface thereof, whereby a positive-locking connection between the rotor and the shaft can be achieved. As an alternative to directly injection molding the rotor on the shaft, it is also conceivable to provide a metallic adaptor piece so that in this case, the rotor is connected to the metallic adaptor piece via a positive-locking connection and the adaptor piece, in turn, is connected to the shaft in a rotationally fixed manner. Through this, wear-related replacement of the rotor of the vacuum pump is possible in a comparatively simple manner.

In another advantageous embodiment of the invention, a coupling is arranged on the shaft, which coupling permits separating the pendulum-slide cell oil pump and the vacuum pump. Such a coupling thus enables connecting or disconnecting the vacuum pump as needed. Usually, the pendulum-slide cell oil pump is mechanically driven and the vacuum pump is driven via the latter or the shaft. By providing a coupling between the pendulum-slide cell oil pump and the vacuum pump, the latter can be connected or disconnected as needed and can also be adapted with regard to its capacity, which is carried out by partially closing or opening the coupling, for example.

Further important features and advantages of the invention arise from the sub-claims, from the drawings, and from the associated description of the figures based on the drawings.

It is to be understood that the above-mentioned features and the features still to be explained hereinafter are usable not only in the respective mentioned combination, but also in other combinations or alone, without departing from the context of the present invention.

Preferred exemplary embodiments of the invention are illustrated in the drawings and are explained in more detail in the following description, wherein identical reference numbers refer to identical or similar or functionally identical components.

### BRIEF DESCRIPTION OF THE DRAWINGS

In the figures, schematically:

FIG. 1 shows an exploded view of a pump arrangement according to the invention,

FIG. 2 shows a side view of the pump arrangement,

FIG. 3 shows a sectional view through the pump arrangement according to FIG. 2,

FIG. 4 shows a detailed view of a vacuum pump of the pump arrangement.

### DETAILED DESCRIPTION

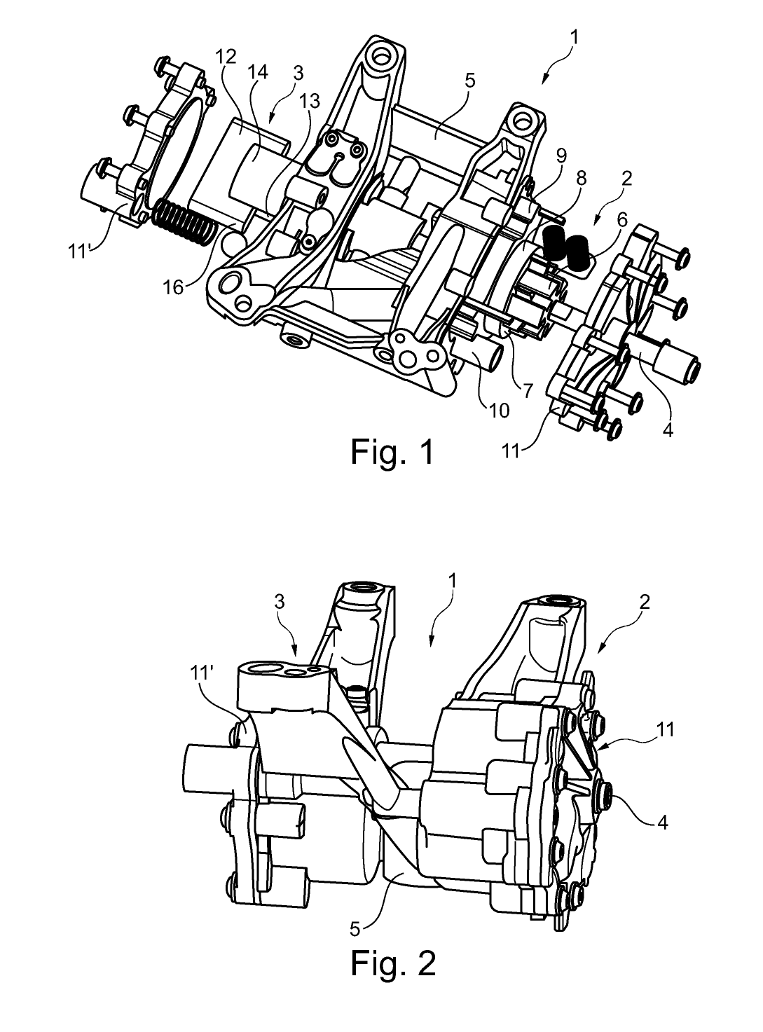

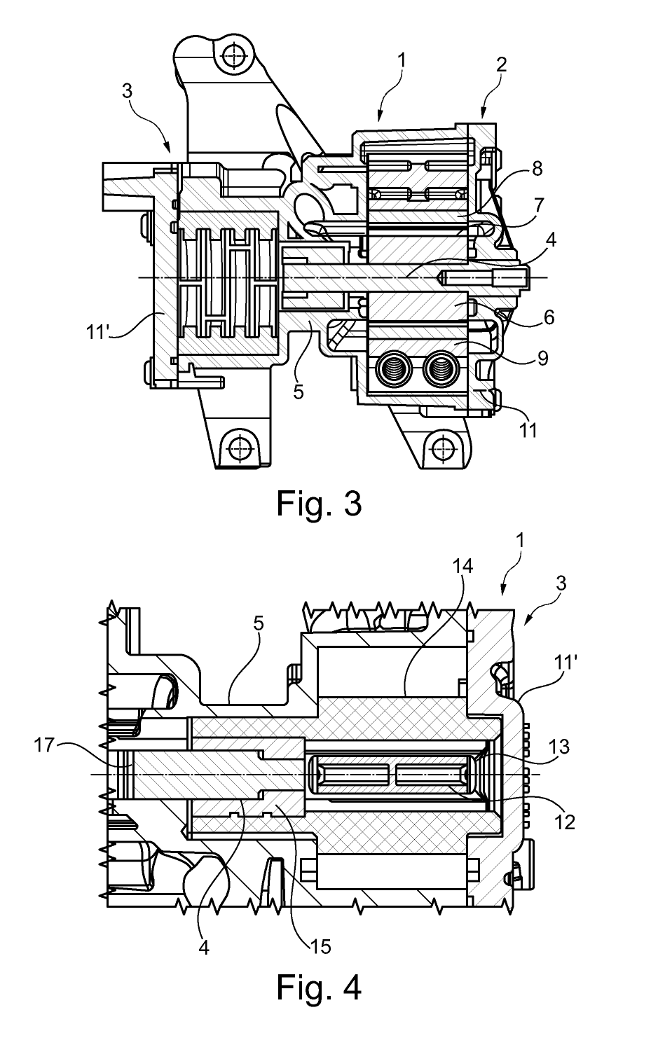

According to the FIGS. 1 to 3, a pump arrangement 1 according to the invention has a pendulum-slide cell oil pump 2 and a vacuum pump 3, both of which are driven by a common shaft 4 and are mounted in a common housing 5. In the pendulum-slide cell oil pump 2, a lubricant is pumped, for example for lubricating an internal combustion engine, which is not shown here. For this purpose, the pendulum-slide cell oil pump 2 has an inner rotor 6 and an outer rotor 8 connected thereto via pendulums 7. The outer rotor 8 is supported in a pivotable slide 9 which controls the delivery rate of the pendulum-slide cell oil pump 2 by adjusting the eccentricity of the outer rotor 8. The slide 9 is rotatably mounted on a pivot pin 10. The pendulum-slide cell oil pump 2 is closed with respect to the housing 5 by means of a cover 11.

When viewing the vacuum pump 3, it can be seen that the vacuum pump is designed as a rotary vane pump or vane pump having only a single vane 12. The vane 12 is displaceably mounted in a rotor 14 having a transverse groove 13. The rotor 14, in turn, is preferably made from plastics and therefore can be produced not only in a cost-effective manner, but at the same time also in high quality. The vacuum pump 3 is closed by a cover 11′ which, for example, is also made from a plastic material, in particular a thermoset or thermoplastic. The rotor 14 can be injection molded directly on the shaft 4 or on a metallic adaptor piece 15 (cf. FIG. 4) which, in turn, is connected to the shaft 4 in a rotationally fixed manner. FIGS. 1 to 3 further show that the pendulum-slide cell oil pump 2 and the vacuum pump 3 are arranged coaxially, wherein the shaft 4 is preferably exclusively mounted in the housing 5. When providing the metallic adaptor piece 15, the outer circumference of the latter can have geometries which engage in a positive-locking manner with the plastic material injected around the rotor 14 and thereby ensure the rotationally fixed connection between the metallic adaptor piece 15 and the rotor 14. Moreover, wear protection caps 16 (cf. FIG. 1), which at least reduce sliding abrasion during the operation of the vacuum pump 3, can be arranged on the vane 12 of the vacuum pump 3.

With the pump arrangement 1 according to the invention, it is possible to not only significantly reduce the installation space compared with two pumps which up to now are produced separately, but it is also possible to achieve a functional integration associated with the resulting cost advantages. Moreover, friction loss can also be reduced since for the rotor 14 of the vacuum pump 3 as well as for the inner rotor 6 of the pendulum-slide cell oil pump 2, the shaft 4 has to be mounted only in the housing 5, that is, in one place. Moreover, the pendulum-slide cell oil pump 2 can be a two-stage design and therefore can comprise two pressure chambers in a manner known per se. A design as a fully variable pendulum-slide cell oil pump 2 is also conceivable.

Usually, the pump arrangement 1 according to the invention is driven by means of a drive that is mechanically coupled to the shaft 4 in the region of the pendulum-slide cell oil pump 2 so that the inner rotor 6 as well as the rotor 14 always have the same rotational speed. If individual controlling of the vacuum pump is desired, for example for a brake system of a motor vehicle, a coupling device 17 can be provided in the housing 5, which coupling permits separating the pendulum-slide cell oil pump 2 and the vacuum pump 3.

1. A pump arrangement, comprising: a pendulum-slide cell oil pump and a vacuum pump, wherein the pendulum-slide cell oil pump and the vacuum pump are driven by a common shaft and mounted in a common housing.

2. The pump arrangement according to claim 1, wherein the vacuum pump is a rotary vane pump and includes a rotor composed of a plastic.

3. The pump arrangement according to claim 1, wherein the pendulum-slide cell oil pump and the vacuum pump are arranged coaxially.

4. The pump arrangement according to claim 2, wherein the rotor of the vacuum pump has a transverse groove and a vane slideably supported in the transverse groove.

5. The pump arrangement according to claim 2, wherein the pendulum-slide cell oil pump includes at least two pressure chambers operable to maintain at least two different pressure levels.

6. The pump arrangement according to claim 5, further comprising an external control arrangement operable to adjust the pendulum-slide cell oil pump via a slide disposed on the pendulum-slide cell oil pump by a control pressure applied from an external source, wherein the external control arrangement is operable to provide the pendulum-slide cell oil pump at least three different defined pressure levels.

7. The pump arrangement according to claim 1, wherein the shaft includes a coupling, wherein the pendulum-slide cell oil pump is separable from the vacuum pump via the coupling.

8. The pump arrangement according to claim 2, wherein the rotor of the vacuum pump is connected to a metallic adaptor piece via a positive-locking connection, wherein the adaptor piece is connected to the shaft in a rotationally fixed manner.

9. The pump arrangement according to claim 8, wherein the rotor of the vacuum is composed of a plastic material and the adaptor piece is injection molded in the rotor.

10. The pump arrangement according to claim 9, wherein the plastic material is a thermoplastic.

11. The pump arrangement according to claim 1, wherein the pendulum-slide cell oil pump includes an inner rotor fixedly connected to one end of the shaft and the vacuum pump includes a rotor fixedly connected to the other end of the shaft, wherein the inner rotor of the pendulum-slide cell oil pump and the rotor of the vacuum pump are arranged coaxially to one another.

12. The pump arrangement according to claim 2, wherein the shaft includes a coupling disposed between the pendulum-slide cell oil pump and the vacuum pump, wherein the pendulum-slide cell oil pump is separable from the vacuum pump via the coupling.

13. The pump arrangement according to claim 3, wherein the rotor of the vacuum pump includes a transverse groove and a vane, wherein the vane is slideably supported in the transverse groove.

14. The pump arrangement according to claim 3, wherein the shaft includes a coupling disposed between the pendulum-slide cell oil pump and the vacuum pump, wherein the pendulum-slide cell oil pump is separable from the vacuum pump via the coupling.

15. The pump arrangement according to claim 3, wherein the rotor of the vacuum pump is connected to a metallic adapter piece via a positive locking connection, wherein the adapter piece is connected in a rotationally fixed manner to the shaft.

16. The pump arrangement according to claim 15, wherein the rotor of the vacuum is composed of a plastic material and the adapter piece is injection molded in the rotor.

17. The pump arrangement according to claim 4, further comprising a protection cap arranged on the vane to reduce abrasion during operation.

18. The pump arrangement according to claim 4, wherein the pendulum-slide cell oil pump includes at least two pressure chambers operable to maintain at least two different pressure levels.

19. A pump arrangement, comprising:
a housing defining a common cavity;
a pendulum-slide cell oil pump disposed at one side of the housing in the cavity, the pendulum-slide cell oil pump including an inner rotor connected to an outer rotor via at least one pendulum;
a vacuum pump disposed at the other side of the housing in the cavity, the vacuum pump including a rotor;
a shaft mounted in the housing between the pendulum-slide cell oil pump and the vacuum pump, the shaft driveably coupling the pendulum-slide cell oil pump to the vacuum pump;
wherein the inner rotor of the pendulum-slide cell oil pump is fixedly connected to one end of the shaft and the rotor of the vacuum pump fixedly connected to the other end of the shaft, wherein the inner rotor of the pendulum-slide cell oil pump and the rotor of the vacuum pump are arranged coaxially to one another.

20. The pump arrangement according to claim 19, wherein the shaft includes a coupling disposed between the pendulum-slide cell oil pump and the vacuum pump, wherein the vacuum pump is separable from the pendulum-slide cell oil pump via the coupling.
